(19) United States
(12) Patent Application Publication
(10) Pub. No.: US 2026/0349497 A1
(43) Pub. Date: Nov. 5, 2026

(54) METHODS OF OPERATING A HOUSEHOLD APPLIANCE

(71) Applicant: Haier US Appliance Solutions, Inc., Wilmington, DE (US)

(72) Inventors: Zachary Tencza, Louisville, KY (US); Jeremy Davidson Mahaney, Louisville, KY (US); Mark Anthony Didat, Floyds Knobs, KY (US); Steven Michael Recio, Louisville, KY (US); Brian Keith Owens, Lexington, KY (US)

(21) Appl. No.: 19/194,094

(22) Filed: Apr. 30, 2025

(51) Int. Cl. G06F 3/01; D06F 34/28; G09G 5/10

(52) U.S. Cl. CPC G06F 3/011; G09G 5/10; D06F 34/28; G09G 2320/0626; G09G 2354/00

(57) ABSTRACT

A method of operating a household appliance includes activating a sensing device of the appliance such that the sensing device generates data indicative of the presence of a user of the appliance. Additionally, the method includes detecting the presence of the user based on the data indicative of the presence of the user generated by the sensing device. Furthermore, the method includes selecting a power mode of the appliance based on the detected presence of the user. Moreover, the method includes operating a component of the appliance based on the selected power mode of the appliance.

### FIELD

The present subject matter relates generally to household appliances and methods of operating the household appliances.

### BACKGROUND

Household appliances are utilized generally for a variety of tasks by a variety of users. For example, a household may include such appliances as laundry appliances, e.g., a washer and/or dryer, kitchen appliances, e.g., a refrigerator, a microwave, and/or a coffee maker, along with room air conditioners and other various appliances.

Generally, a user manually activates such appliances in order to utilize the basic functions of the appliances. For example, some appliances may include user interfaces in which appliance users manually select cycles or modes of operation appliances. The user interfaces may include various components, such as LED or LCD displays, that are turned on for long periods of time and, thus, consume large quantities of energy.

Accordingly, methods of operating a household appliance to reduce the amount of energy consumed by the appliance would be useful. Specifically, methods of operating the household appliance associated with the detection of the user would be particularly beneficial.

### BRIEF DESCRIPTION

Aspects and advantages of the invention will be set forth in part in the following description, or may be obvious from the description, or may be learned through practice of the invention.

In accordance with one embodiment of the present disclosure, a method of operating a household appliance is provided. The method includes receiving, with a controller, an input that a remote user interface device is located at a distance from the appliance that is equal to or less than a predetermined distance threshold. Additionally, after receiving the input, the method includes activating, with the controller, a sensing device of the appliance, whereby the sensing device generates data indicative of a presence of a user. Furthermore, the method includes detecting, with the controller, the presence of the user based on the data indicative of the presence of the user generated by the sensing device. Moreover, the method includes selecting, with the controller, a power mode of the appliance based on the detected presence of the user. Additionally, the method includes operating, with the controller, a component of the appliance based on the selected power mode of the appliance.

In accordance with another embodiment of the present disclosure, a method of operating a household appliance is provided. The method includes activating, with a controller, a sensing device of the appliance, whereby the sensing device generates data indicative of a distance of a user from the appliance. Additionally, the method includes detecting, with the controller, the distance of the user from the appliance based on the data indicative of the distance of the user from the appliance generated by the sensing device. Furthermore, the method includes selecting, with the controller, a power mode of the appliance based on the detected distance of the user from the appliance. Moreover, the method includes operating, with the controller, a component of the appliance based on the selected power mode of the appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of exemplary laundry appliances in accordance with one or more embodiments of the present disclosure.

FIG. 2 provides a partial perspective view of an exemplary air conditioner appliance in accordance with additional embodiments of the present disclosure.

FIG. 3 provides a perspective view of an oven appliance in accordance with additional embodiments of the present disclosure.

FIG. 4 provides a perspective view of a microwave oven appliance in accordance with additional embodiments of the present disclosure.

FIG. 5 provides a perspective view of a refrigeration appliance in accordance with additional embodiments of the present disclosure.

FIG. 6 provides a front view of a dishwashing appliance in accordance with additional embodiments of the present disclosure.

FIG. 7 provides a schematic diagram of an appliance in communication with a remote user interface device and a remote database according to one or more embodiments of the present disclosure.

FIG. 8 provides a flowchart illustrating a first example method of operating a household appliance according to one or more embodiments of the present disclosure.

FIG. 9 provides a flowchart illustrating a second example method of operating a household appliance according to one or more embodiments of the present disclosure.

The use of the same reference numbers in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

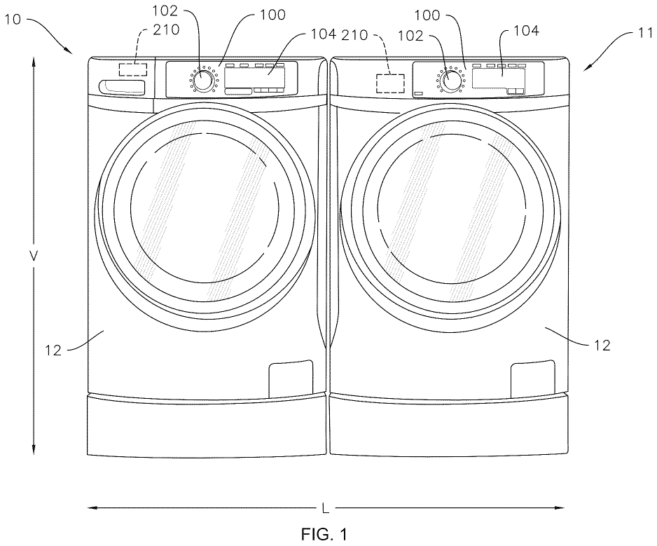

As may be seen in FIGS. 1 through 6, in accordance with one or more embodiments of the present subject matter, an appliance 10 having a cabinet 12 is provided. The cabinet 12 defines a vertical direction V, a lateral direction L, and a transverse direction T that are mutually perpendicular. The cabinet 12 extends between a top portion 13 and a bottom portion 14 along the vertical direction V. Cabinet 12 also extends between a first side portion 15 and a second side portion 16, e.g., along the lateral direction L, and a front portion 17 and a back portion 18, e.g., along the transverse direction T.

A user interface panel 100 and a user input device 102 may be positioned on an exterior of the cabinet 12. The user input device 102 is generally positioned proximate to the user interface panel 100, and in some embodiments, the user input device 102 may be positioned on the user interface panel 100. The appliance 10 may also include features for detecting the presence of a user, as will be described in more detail below.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a light emitting display. For example, the display component 104 may be a backlit touchscreen capable of receiving a user input such that the display component 104 may also be a user input device in addition to or instead of the user input device 102.

Generally, the appliance 10 may include a controller 210 in operative communication with the user input device 102 and/or the display component 104. The user interface panel 100, the user input device 102, and the display component 104 may be in communication with the controller 210 via, for example, one or more signal lines or shared communication busses. Input/output (“I/O”) signals may be routed between controller 210 and various operational components of the appliance 10. Operation of the appliance 10 can be regulated by the controller 210 that is operatively coupled to the user interface panel 100. A user interface panel 100 may, for example, provide selections for user manipulation of the operation of an appliance, e.g., via user input device 102 and/or display component 104. In response to user manipulation of the user interface panel 100, user input device 102, and/or display component 104, the controller 210 may operate various components of the appliance 10. Controller 210 may include a memory and one or more microprocessors, CPUs or the like, such as general or special purpose microprocessors operable to execute programming instructions or micro-control code associated with operation of the appliance 10. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the appliance 10 by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, the appliance 10 may be one of a set of two or more appliances. In the exemplary embodiment illustrated in FIG. 1, appliance 10 may be one of a pair of laundry appliances, e.g., the appliance may be a washer 10 and/or dryer 11. In some embodiments, such as illustrated in FIG. 1, the user input device 102 of each appliance 10 and 11 may be positioned on the user interface panel 100. Furthermore, as illustrated in FIG. 1, the display component 104 may also be positioned on the user interface panel 100.

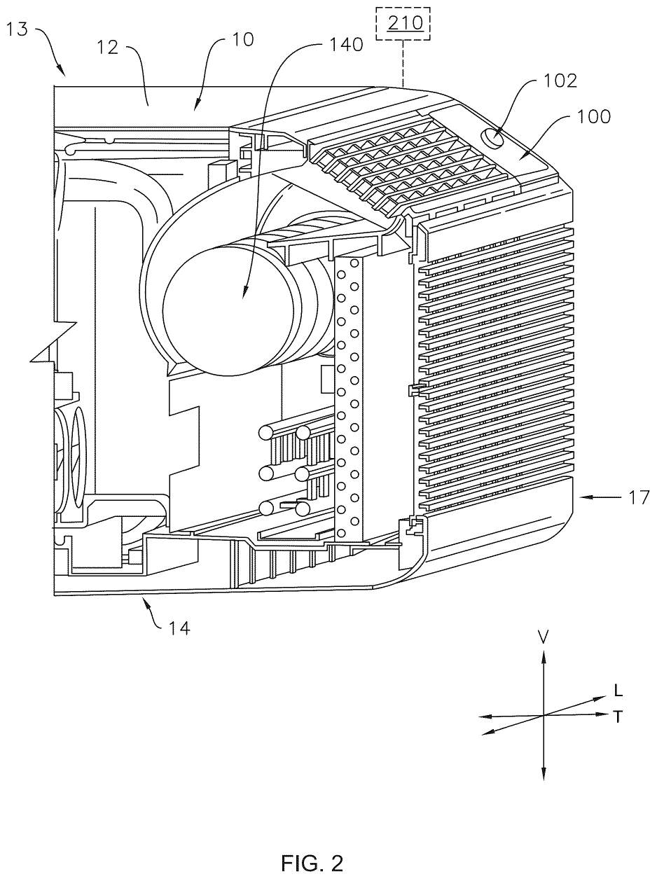

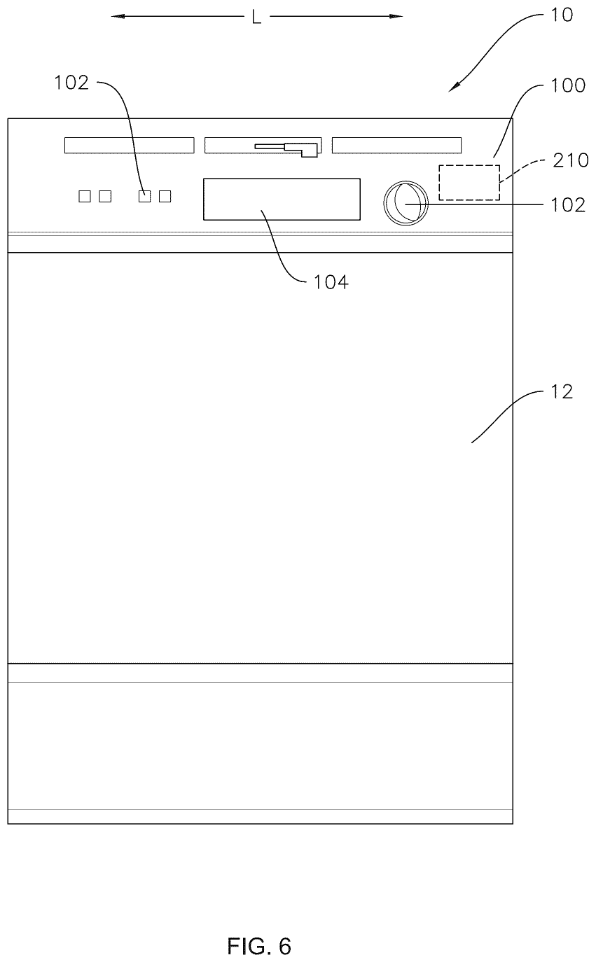

FIG. 2 illustrates another example embodiment of the appliance 10, wherein the appliance 10 is a room air conditioner. As illustrated, the exemplary air conditioner 10 includes cabinet 12, user interface panel 100 and user input device 102. In the illustrated example of FIG. 2, the user input device 102 is a control knob, similar to those illustrated in FIGS. 1 and 6. It should be appreciated that the user interface panel 100 may also include a display component (not shown), such as the display component 104 described above. For example, the display component 104 may may be the backlit touchscreen capable of receiving the user input such that the display component may also be the user input device in addition to or instead of the user input device 102. The air conditioner 10 may also include a controller 210, and the controller 210 may be configured to activate the air conditioner 10, e.g., by turning on fan 140 to circulate air.

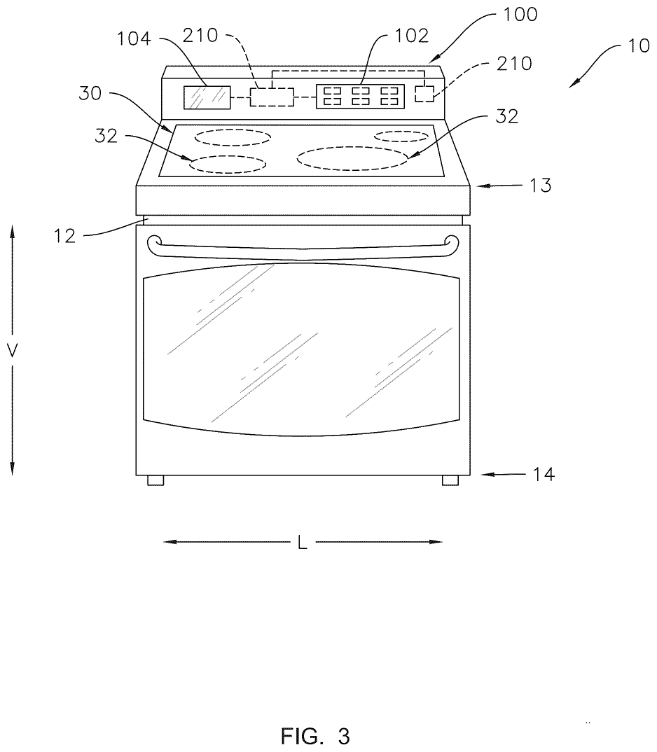

FIG. 3 illustrates another example embodiment of the appliance 10, wherein the appliance 10 is an oven appliance including a cooktop and an oven. The exemplary oven appliance 10 illustrated in FIG. 3 includes user interface panel 100 and user input device 102, e.g., the display component 104. In the illustrated example of FIG. 3, the display component 104 is a backlit touchscreen. Oven appliance 10 is provided by way of example only and is not intended to limit the present subject matter in any aspect. Thus, the present subject matter may be used with other oven appliance configurations, e.g., that define one or more interior cavities for the receipt of food and/or having different heating element arrangements than what is shown in FIG. 3. Further, the present subject matter may be used in a stand-alone cooktop, a hot plate, or any other suitable appliance.

As illustrated in FIG. 3, the exemplary oven appliance 10 generally includes a cooking assembly. The cooking assembly may include one or more heating elements. For example, in some embodiments, the cooking assembly includes cabinet 12 which in some embodiments may be an insulated cabinet 12 with an interior cooking chamber (not shown) configured for the receipt of one or more food items to be cooked defined within insulated cabinet 12. Such cooking chambers are generally understood by those of ordinary skill in the art and are not described in further detail herein. The oven appliance 10 may additionally include a cooktop 30. Cooktop 30 may be disposed on the cabinet 12 generally at or proximate to top portion 13. Cooktop 30 includes one or more heating assemblies 32, e.g., electric heating elements or gas burners, thereon.

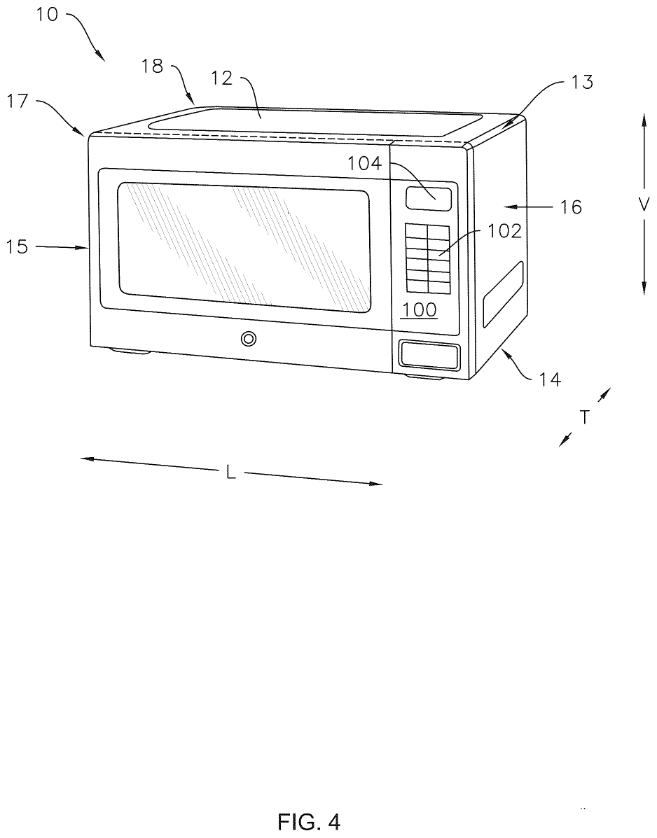

In another example embodiment, the appliance 10 may be a microwave oven appliance, such as is illustrated in FIG. 4. It should be understood that the microwave oven appliance 10 is provided by way of example only. Thus, the present subject matter is not limited to microwave oven appliance 10 and may be utilized in any suitable appliance.

Microwave oven appliance 10 includes a cabinet 12. A cooking chamber is defined within the cabinet 12 of the microwave oven appliance 10. The microwave oven appliance 10 of FIG. 4 is configured to heat articles, e.g., food or beverages, within the cooking chamber using electromagnetic radiation. The microwave oven appliance 10 may include various components which operate to produce the electromagnetic radiation, as is generally understood. For example, the microwave oven appliance 10 may include a magnetron (such as, for example, a cavity magnetron), a high voltage transformer, a high voltage capacitor and a high voltage diode. The transformer may provide energy from a suitable energy source (such as an electrical outlet) to the magnetron. The magnetron may convert the energy to electromagnetic radiation, specifically microwave radiation. The capacitor generally connects the magnetron and transformer, such as via high voltage diode, to a chassis. Microwave radiation produced by the magnetron may be transmitted through a waveguide to the cooking chamber. The structure and intended function of microwave ovens are generally understood by those of ordinary skill in the art and are not described in further detail herein.

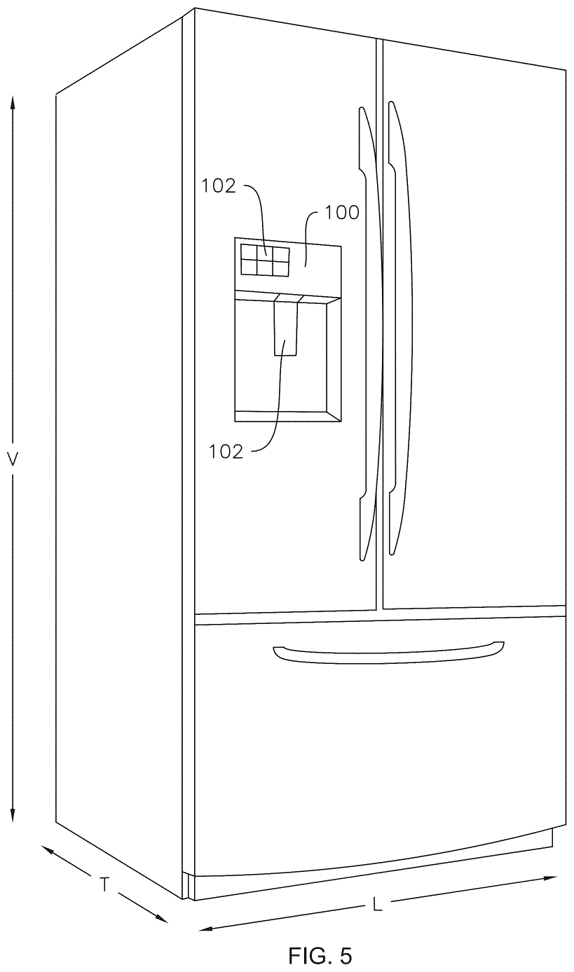

In another embodiment, the appliance 10 may be a refrigerator appliance, such as is illustrated in FIG. 5. FIG. 5 provides a perspective view of the refrigerator appliance 10 according to an exemplary embodiment of the present subject matter. The refrigerator appliance 10 includes a cabinet 12. The example refrigerator appliance 10 depicted in FIG. 5 is generally referred to as a bottom mount refrigerator appliance. However, it should be understood that the refrigerator appliance 10 is provided by way of example only. Thus, the present subject matter is not limited to the refrigerator appliance 10 and may be utilized in any suitable appliance, including without limitation, side-by-side style refrigerator appliances or top mount refrigerator appliances as well.

The refrigerator appliance 10 may also include a dispensing assembly for dispensing, e.g., liquid water and/or ice to, for example, a dispenser recess defined on the exterior of cabinet 12, as is generally understood in the art. Thus, in some embodiments, the appliance 10 may be a refrigerator appliance and the user interface panel 100 may be or include a control panel of the dispensing assembly. Further with reference to the exemplary embodiment illustrated in FIG. 5, in some exemplary embodiments including refrigerator appliance 10 and a dispensing assembly, the user input device 102 may be a paddle of the dispensing assembly, the paddle 102 in FIG. 5 being an exemplary embodiment of the user input device. Such dispensing assemblies, including actuators therefor such as paddles, levers, etc., are generally understood in the art and are not described further herein. The refrigerator appliance 10 may also include a display component (not shown) such as the display component 104 described above. For example, the display component may be the backlit touchscreen.

FIG. 6 provides a front view of a dishwashing appliance 10 according to yet another exemplary embodiment of the present subject matter. The dishwashing appliance includes a cabinet 12 with a user interface panel 100 thereon. In the illustrated example embodiment of the FIG. 6, the user interface panel includes multiple user input devices 102, e.g., a knob and a plurality of buttons, as well as display component 104, which may be a backlit touchscreen. In various embodiments, any suitable combination of any one or more of the illustrated user input devices 102 and display component 104 may be provided.

According to various embodiments of the present disclosure, the appliance 10 may take the form of any of the examples described above or may be any other household appliance where improved user detection and greater responsiveness to the detected user is desired. Thus, it will be understood that the present subject matter is not limited to any particular household appliance.

It should be understood that “household appliance” and/or “appliance” are used herein to describe appliances typically used or intended for common domestic tasks, such as a laundry appliance, e.g., as illustrated in FIGS. 1 through 3, or an air conditioner appliance (see, e.g., FIG. 4), a dishwashing appliance, a refrigerator, a water heater, etc., and any other household appliance which performs similar functions in addition to network communication and data processing. Thus, devices such as personal computers, routers, and other similar devices whose primary functions are network communication and/or data processing are not considered household appliances as used herein.

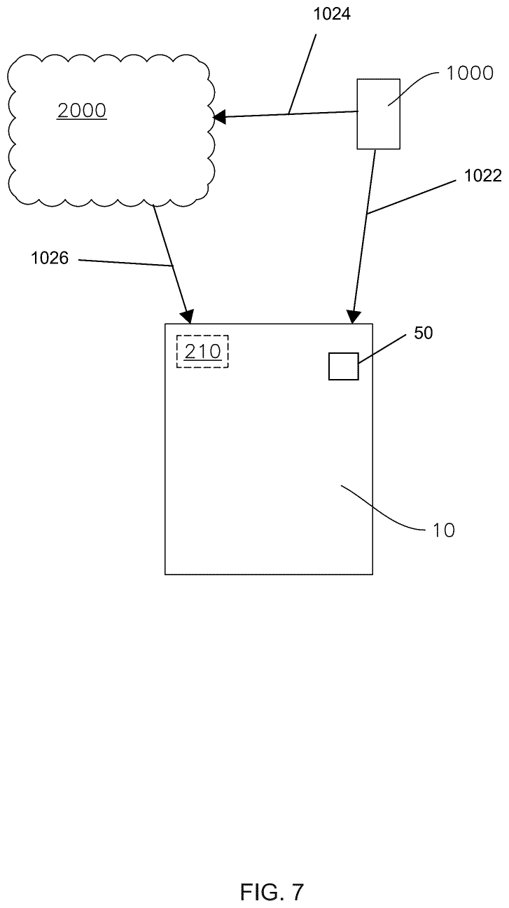

Turning now to FIG. 7, the appliance 10 and, in particular, controller 210 thereof, may be configured to communicate with a separate device external to the appliance, such as a communications device or other remote user interface device 1000. The remote user interface device 1000 may be a laptop computer, smartphone, tablet, personal computer, wearable device, smart home system, and/or various other suitable devices. The appliance 10, e.g., controller 210 thereof, may also be configured to communicate with a remote database 2000, such as a cloud server. The appliance 10 may be in communication with the remote user interface device 1000 device through various possible communication connections and interfaces.

The remote user interface device 1000 may include a memory for storing and retrieving programming instructions. Thus, the remote user interface device 1000 may provide a remote user interface which may be an additional user interface to the user interface panel 100. For example, the remote user interface device 1000 may be a smartphone operable to store and run applications, also known as “apps,” and the remote user interface may be provided as a smartphone app.

The appliance 10 and the remote user interface device 1000 may be matched in wireless communication, e.g., connected to the same wireless network. The appliance 10 may communicate with the remote user interface device 1000 via radio such as BLUETOOTH® or any other suitable wireless network having a layer protocol architecture. For example, the remote user interface device 1000 may send an input or signal 1022 to the appliance 10, e.g., controller 210 thereof, that is received by the appliance 10, e.g., controller 210. The signal 1022 may be a radio signal indicating the location or distance of the remote user interface device 1000 relative to the appliance 10.

As mentioned above, the appliance 10 may be configured to communicate wirelessly with the remote database 2000. The remote database 2000 may be, e.g., a cloud-based data storage system. For example, the appliance 10, e.g., controller 210, may communicate with the remote database 2000 over the Internet, which the appliance 10 may access via WI-FI®, such as from a WI-FI® access point in a user's home. Furthermore, the remote user interface device 1000 may communicate with the appliance 10, e.g., controller 210, via the remote database 2000. For example, the remote user interface device 1000 may send the input or signal 1024 to the remote database 2000, e.g., over the Internet via WI-FI® and/or via cellular communications, that is received by the appliance 10, e.g., controller 210, as a signal 1026 from the remote database 2000. The signals 1024, 1026 may be Global Navigation Satellite System (GNSS) based signals, e.g., Global Positioning System (GPS) signals, indicating the location or distance of the remote user interface device 1000 relative to the appliance 10.

In embodiments in which the appliance 10 includes the display component 104, the controller 210 may activate the display component 104 by turning on or waking the display component 104, which may also include providing a greeting or other notification to the user on the display component 104. In some embodiments, the display component 104 may be a light emitting display 104, e.g., such as the backlit touchscreen display described above, of which a brightness level of the display component 104 is adjustable, e.g., increased, dimmed, and/or turned off/deactivated entirely. For example, the brightness level of the display component 104 may be automatically adjustable by the controller 210 in response to a received input, e.g., an input received from a sensing device of the appliance 10 indicative of a presence of a user and/or a proximity/distance of the user from the appliance 10. Upon activation of the display component 104, light may be emitted by the display component 104.

Still referring to FIG. 7, the appliance 10 may include a sensing device 50. The sensing device 50 may generate data indicative of a presence of a user and/or a proximity/distance of the user from the appliance 10. For example, in some embodiments, the sensing device 50 may be a WI-FI® receiver 50 of the appliance that generates Channel State Information (CSI) data, which may describe the characteristics/properties of one or more wireless communication channels. The CSI data generated by the WI-FI® receiver 50 may indicate how a signal propagates through the environment, and may indicate signal scattering, fading, power decay, signal receipt delay, and/or the like. When a user is near the appliance 10, e.g., between 0.1 millimeters and 10 meters, and, thus, near the WI-FI® receiver 50, the CSI data generated by the WI-FI® receiver 50 may be affected. For example, the presence of the user, as opposed to the absence of the user, and the distance of the user from the appliance 10 may uniquely affect scattering, fading, power decay, and/or receipt delay of the signal. Thus, the CSI data may indicate the presence of the user and/or the proximity/distance of the user from the appliance 10. Additionally, the WI-FI® receiver 50 and/or other sensing device 50 may be in operative communication with/operatively coupled to the controller 210. In this respect, as will be described below, the controller 210 may receive and utilize data from the WI-FI® receiver 50 and/or other sensing device 50, such as the data indicating the presence of the user and/or the distance of the user from the appliance 10, to control the operation of the appliance 10.

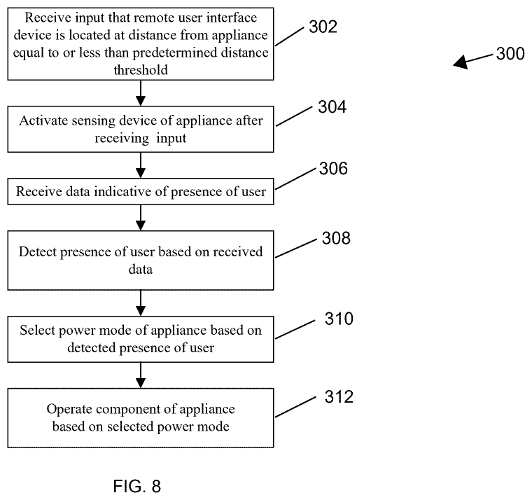

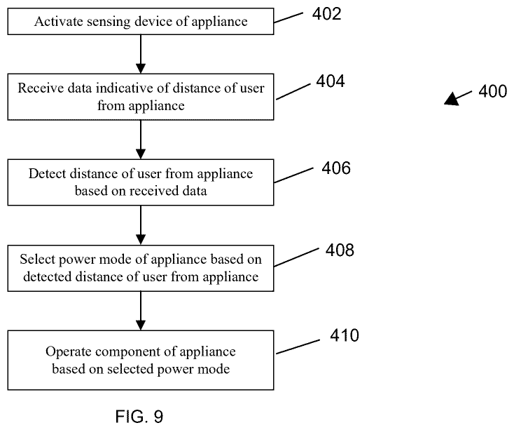

Referring now generally to FIGS. 8 and 9, the methods 300 and 400 may be interrelated and/or may have one or more steps from one of the methods 300 or 400 combined with one or more of the other methods 300 and/or 400. Thus, those of ordinary skill in the art will recognize that the various steps of the exemplary methods described herein may be combined in various ways to arrive at additional embodiments within the scope of the present disclosure.

FIGS. 8 and 9 depict steps in a particular order for purpose of illustration and discussion. Those of ordinary skill in the art, using the disclosures provided herein, will understand that (except as otherwise indicated) methods 300 and 400 are not mutually exclusive. Moreover, the steps of the methods 300 and 400 can be modified, adapted, rearranged, omitted, interchanged, or expanded in various ways without deviating from the scope of the present disclosure.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Turning now to FIG. 8, an embodiment of the present disclosure may include a method for operating a household appliance, such as one or more of the exemplary appliances 10 described above in FIGS. 1 through 7.

As shown in FIG. 8, method 300 may include receiving an input that a remote user interface device is located at a distance from an appliance that is equal to or less than a predetermined distance threshold, e.g., as indicated at (302) in FIG. 8. Specifically, the controller 210 of the appliance 10 may receive an input that the remote user interface device 1000 is located within a distance from the appliance 10 that is equal to or less than the predetermined distance threshold, e.g., at or within a geofence. The geofence may be an “invisible fence” of which the boundaries are stored within a memory, such as the memory of the controller 210 and/or a controller of the remote user interface device 1000, and/or within the remote database 2000. When the user is at the distance from the appliance 10 that is equal to or less than the predetermined distance threshold, the user is at or within the geofence. The input received by the controller 210 may be the signal 1026 transmitted by the remote database 2000 from the signal 1024 received by the remote database 2000 from the remote user interface device 1000. The signals 1024, 1026 may be indicative of the location of the remote user interface device 1000. For example, the remote user interface device 1000 may be configured to transmit, and the controller 210 may be configured to receive, a GNSS based signal, e.g., GPS signal, that indicates the location, e.g., coordinates, of the remote user interface device 1000. The controller 210 may determine the location of the remote user interface device 1000 relative to the appliance 10 from the received signal, and whether the remote user interface device 1000 is at/equal to or within the predetermined distance threshold. Additionally, or alternatively, the input received by the controller 210 may be a radio signal, such as a BLUETOOTH® signal, transmitted by the remote user interface device 1000 directly to a radio receiver of the appliance 10 for receiving/processing by the controller 210. As will be described below, after the controller 210 receives the input that the remote user interface device 1000 is located within or at/equal to the predetermined distance threshold, the controller 210 activates the sensing device 50 of the appliance 10.

Additionally, after receiving the input, the method 300 may include activating a sensing device of the appliance, e.g., as indicated at (304) in FIG. 8. Specifically, the controller 210 may activate, e.g., turn on/wake up, the sensing device 50, e.g., WI-FI® receiver 50, of the appliance 10 after receiving the input at (302). The activation of the sensing device 50 permits the sensing device 50 to generate data indicative of the presence of the user. In some exemplary embodiments, the sensing device 50 generates data indicative of the distance of the user from the appliance 10 in response to the activation of the sensing device 50. For example, the WI-FI® receiver 50 may generate the CSI data described above, which may indicate a delay in the propagation or receipt of a WI-FI® signal as compared to the propagation or receipt of the WI-FI® signal when no user is present. The signal delay may be due to the presence of the user. Furthermore, the length of time of the delay may indicate the distance value of the user from the appliance 10. For example, the CSI data may indicate that the user is present and between 0.1 millimeters and 10 meters from the appliance 10.

Furthermore, the method 300 may include receiving data indicative of the presence of the user, e.g., as indicated at (306) in FIG. 8. Specifically, after the sensing device 50 has been activated, the controller 210 may receive the data, e.g., CSI data, from the WI-FI® receiver 50 indicative of the presence of the user. In some exemplary embodiments, the controller 210 may receive data from the WI-FI® receiver 50 indicative of the distance of the user from the appliance 10.

Moreover, the method 300 may include detecting the presence of the user based on the received data, e.g., as indicated at (308) in FIG. 8. Specifically, the controller 210 may detect the presence of the user based on the data, e.g., CSI data, received from the sensing device 50 at (306). In some exemplary embodiments, the controller 210 may detect or determine the distance of the user from the appliance 10 based on the data received from the sensing device 50. For example, the controller 210 may access a look-up table stored within its memory that correlates the CSI data, e.g., signal receipt delay, received from the WI-FI® receiver 50 to distance values.

Additionally, the method 300 may include selecting a power mode of the appliance based on the detected presence of the user, e.g., as indicated at (310) in FIG. 8. Specifically, the controller 210 may select the power mode of the appliance 10, such as the power mode of the display component 104, based on the presence of the user detected at (308). In some exemplary embodiments, the controller 210 may select the power mode of the display component 104 based on the detected distance of the user from the appliance 10. For example, the controller 210 may compare the detected distance of the user from the appliance 10 to a plurality of distance threshold ranges, such as a first distance threshold range and a second distance threshold range. However, it should be appreciated that the detected distance of the user from the appliance 10 may be compared to any suitable number of distance threshold ranges, such as three threshold ranges and/or more than three threshold ranges. All values of the second distance threshold range may be greater than all values of the first distance threshold range. For example, the first distance threshold range may include values between 0.1 millimeters and 10 meters, and the second distance threshold range may include values between 10 meters and 20 meters. However, it should be appreciated that the second distance threshold range may be a threshold range greater than a particular value, such as 15 meters, of which detection of the presence of the user is not feasible and, thus, the user is considered not present.

Additionally, when selecting the power mode, the controller 210 may determine that the detected distance of the user from the appliance 10 falls within either the first distance threshold range or the second distance threshold range. The user is considered further away from the appliance 10 when the detected distance of the user falls within the second distance threshold range and closer to the appliance 10 when the detected distance of the user falls within the first distance threshold range. Thereafter, the controller 210 may select a first power mode in response to the detected distance falling within the first distance threshold range. Alternatively, the controller 210 may select a second power mode different from the first power mode in response to the detected distance falling within the second distance threshold range.

Since the first power mode is associated with the detection of the user within the first distance threshold and, thus, with the user being closer to the appliance 10 relative to the detection of the user within the second distance threshold, the first power mode may be associated with initiating activity of the appliance 10 or increasing activity of the appliance 10 relative to the second power mode described below. For example, the first power mode may be associated with activating the display component 104, e.g., increasing a brightness level and/or turning on the display component 104. Since the second power mode is associated with the detection of the user within the second distance threshold and, thus, with the user being further away from the appliance 10 relative to the detection of the user within the first distance threshold, the second power mode may be associated with halting activity of the appliance 10 or decreasing activity of the appliance 10 relative to the first power mode. For example, the second power mode may be associated with deactivating the display component 104, e.g., decreasing a brightness level, turning off the display component 104 entirely such that no light is emitted by the display component 104.

Thereafter, the method 300 may include operating a component of the appliance based on the selected power mode of the appliance, e.g., as indicated at (312) in FIG. 8. Specifically, the controller 210 may operate the component of the appliance 10 according to the power mode selected at (310). For example, the controller 210 may operate the display component 104 such that the display component 104 is activated, deactivated, or the brightness level is adjusted according to the power mode selected at (310). In some embodiments, the controller 210 may activate/turn on or increase the brightness level of the display component 104 in response to the first power mode being selected at (310). Additionally, in some embodiments, the controller 210 may deactivate/turn off or decrease the brightness level of the display component 104 in response to the second power mode being selected at (310).

While described herein as including first and second distance thresholds and first and second power modes, it should be appreciated that the method 300 may include any suitable number of distance thresholds to which the detected distance may be compared and/or any suitable number of power modes for selecting.

Another exemplary method of operating an appliance according to one or more embodiments of the present disclosure is illustrated in FIG. 9. As shown in FIG. 9, the exemplary method 400 may include activating a sensing device of the appliance at (402), e.g., as described above with respect to (304) of method 300.

Additionally, the method 400 may include receiving data indicative of the distance of a user from the appliance at (404), e.g., as described above with respect to (306) of method 300. Thereafter, at (406), the method 400 may include detecting the distance of the user from the appliance based on the data received at (404), e.g., as described above with respect to (308) of method 300.

Furthermore, at (408), the method 400 may include selecting a power mode of the appliance based on the detected distance of the user from the appliance, e.g., as described above with respect to (310) of method 300. Thereafter, at (410), the method 400 may include operating a component of the appliance based on the selected power mode, e.g., as described above with respect to (312) of method 300.

Additionally, in some embodiments, the methods 300 and/or 400 may include receiving an input associated with an anticipated presence of a user. Specifically, the controller 210 of the appliance 10 and/or the remote user interface device 1000 may receive an input associated with the anticipated/expected presence of the user. The input may be a schedule of the user. The schedule may indicate the anticipated presence of the user during a predetermined time period, e.g., a time(s) of day that the presence of the user, as detected by the controller 210 at (308) and/or at (406) is expected. In some embodiments, the controller 210 may receive the input, e.g., schedule of the user, from the user, such as via the user input device 102, the display component 104, e.g., the backlit touchscreen display, and/or the remote user interface device 1000. Additionally, or alternatively, in some embodiments, the schedule of the user may be generated, such as by the controller 210 and/or by the remote user interface device 1000. The schedule of the user may be generated based on recorded data of prior/previous detections of the presence of the user during particular time periods. For example, the schedule of the user may be generated according to data stored within the memory of the controller 210 and/or within the memory of the remote user interface device 1000 that indicates that the presence of the user was previously indicated during a time window of 6:00 PM to 10:00 PM.

Thereafter, in some embodiments, the methods 300 and/or 400 may include determining the anticipated presence of the user based on the received input associated with the anticipated presence of the user. Specifically, the controller 210 may determine the anticipated presence of the user based on the received input associated with the anticipated presence of the user. Thereafter, in some embodiments, the methods 300 and/or 400 may include increasing a sensitivity level of the sensing device. Specifically, the controller 210 may increase the sensitivity level of the sensing device 50, e.g., the WI-FI® receiver 50, after determining the anticipated presence of the user. The sensitivity level of the sensing device 50 may be a range of the sensing device 50 in which the sensing device 50 may generate data that indicates the presence of the user and/or the distance of the user from the appliance 10. For example, the sensing device 50 may include a baseline sensitivity level, e.g., between 0.1 millimeters and 5 meters, in which data may be generated indicating the distance of the user from the appliance 10. In this respect, the controller 210 may detect the distance of the user from the appliance 10 between 0.1 millimeters and 5 meters. When the sensitivity level of the sensing device 50 is increased, e.g., between 0.1 millimeters and 10 meters, the controller 210 may detect the distance of the user from the appliance 10 between 0.1 millimeters and 10 meters. After the sensitivity level of the sensing device 50 has been increased, (308) of the method 300 and/or (406) of the method 400 may include detecting the presence of the user at the increased sensitivity level based on the data indicative of the presence of the user generated by the sensing device. Specifically, the controller 210 may detect the presence of the user at the increased sensitivity level of the sensing device 50 based on the data indicative of the presence of the user generated by the sensing device 50.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating an appliance, the method comprising:
receiving, with a controller, an input that a remote user interface device is located at a distance from the appliance that is equal to or less than a predetermined distance threshold;
activating, with the controller, a sensing device of the appliance after receiving the input, whereby the sensing device generates data indicative of a presence of a user;
detecting, with the controller, the presence of the user based on the data indicative of the presence of the user generated by the sensing device;
selecting, with the controller, a power mode of the appliance based on the detected presence of the user; and
operating, with the controller, a component of the appliance based on the selected power mode of the appliance.

2. The method of claim 1, the appliance comprising a user interface including a light emitting display, wherein:
operating the component of the appliance comprises adjusting, with the controller, a brightness level of the light emitting display.

3. The method of claim 1, wherein receiving the input that the remote user interface device is located the distance from the appliance that is equal to or less than the predetermined distance threshold comprises:
receiving, with the controller, at least one of a Global Navigation Satellite System (GNSS) based signal or a radio signal indicating that the remote user interface device is located at the distance from the appliance that is equal to or less than the predetermined distance threshold.

4. The method of claim 1, wherein:
the sensing device comprises a WI-FI receiver configured to generate Channel State Information (CSI) data of a wireless channel; and
the data generated by the sensing device indicative of the presence of the user comprises the CSI data.

5. The method of claim 1, wherein:
the sensing device generating data indicative of the presence of the user comprises the sensing device generating data indicative of a distance of the user from the appliance; and
detecting the presence of the user comprises detecting, with the controller, the distance of the user from the appliance based on the data indicative of the distance of the user from the appliance generated by the sensing device.

6. The method of claim 5, wherein selecting the power mode of the appliance comprises:
selecting, with the controller, the power mode of the appliance based on the detected distance of the user from the appliance.

7. The method of claim 6, wherein selecting the power mode of the appliance based on the detected distance of the user from the appliance comprises:
comparing, with the controller, the detected distance of the user from the appliance to a first distance threshold range and a second distance threshold range, wherein distances within the second distance threshold range are greater than distances within the first distance threshold range;
determining, with the controller, that the detected distance of the user from the appliance falls within the first distance threshold range; and
selecting, with the controller, a first power mode from a first power mode and a second power mode different from the first power mode in response to the detected distance falling within the first distance threshold range.

8. The method of claim 7, the appliance comprising a user interface including a light emitting display, wherein operating the component of the appliance comprises:
activating, with the controller, the light emitting display in response to selecting the first power mode, whereby activation of the light emitting display results in light emitted by the light emitting display.

9. The method of claim 6, wherein selecting the power mode of the appliance based on the detected distance of the user from the appliance comprises:
comparing, with the controller, the detected distance of the user from the appliance to a first distance threshold range and a second distance threshold range, wherein distances within the second distance threshold range are greater than distances within the first distance threshold range;
determining, with the controller, that the detected distance of the user from the appliance falls within the second distance threshold range; and
selecting, with the controller, a second power mode from a first power mode and a second power mode different from the first power mode in response to the detected distance falling within the second distance threshold range.

10. The method of claim 9, the appliance comprising a user interface including a light emitting display, wherein operating the light emitting display comprises:
deactivating, with the controller, the light emitting display of the user interface in response to selecting the second power mode, whereby deactivation of the light emitting display results in no light emitted by the light emitting display.

11. The method of claim 1, further comprising:
receiving an input associated with an anticipated presence of a user;
determining, with the controller, the anticipated presence of the user based on the received input associated with the anticipated presence of the user; and
increasing, with the controller, a sensitivity level of the sensing device after determining the anticipated presence of the user.

12. The method of claim 11, wherein:
detecting the presence of the user comprises detecting, with the controller, the presence of the user at the increased sensitivity level based on the data indicative of the presence of the user generated by the sensing device.

13. The method of claim 11, wherein:
receiving the input associated with the anticipated presence of the user comprises receiving an input associated with a user schedule, the user schedule indicative of the anticipated presence of the user during a predetermined time period.

14. A method of operating an appliance, the method comprising:
activating, with a controller, a sensing device of the appliance, whereby the sensing device generates data indicative of a distance of a user from the appliance;
detecting, with the controller, the distance of the user from the appliance based on the data indicative of the distance of the user from the appliance generated by the sensing device;
selecting, with the controller, a power mode of the appliance based on the detected distance of the user from the appliance; and
operating, with the controller, a component of the appliance based on the selected power mode of the appliance.

15. The method of claim 14, the appliance comprising a user interface comprising a light emitting display, wherein:
operating the component of the appliance comprises adjusting, with the controller, a brightness level of the light emitting display.

16. The method of claim 14, wherein:
the sensing device comprises a WI-FI receiver configured to generate Channel State Information (CSI) data of a wireless channel; and
the data generated by the sensing device indicative of the distance of the user from appliance comprises the CSI data.

17. The method of claim 14, wherein selecting the power mode of the appliance based on the detected distance of the user from the appliance comprises:
comparing, with the controller, the detected distance of the user from the appliance to a first distance threshold range and a second distance threshold range, wherein distances within the second distance threshold range are greater than distances within the first distance threshold range;
determining, with the controller, that the detected distance of the user from the appliance falls within the first distance threshold range; and
selecting, with the controller, a first power mode from a first power mode and a second power mode different from the first power mode in response to the detected distance falling within the first distance threshold range.

18. The method of claim 17, the appliance comprising a user interface including a light emitting display, wherein:
operating the component of the appliance comprises activating, with the controller, the light emitting display of the user interface in response to selecting the first power mode, whereby activation of the light emitting display results in light emitted by the light emitting display.

19. The method of claim 14, wherein selecting the power mode of the appliance based on the detected distance of the user from the appliance comprises:
comparing, with the controller, the detected distance of the user from the appliance to a first distance threshold range and a second distance threshold range, wherein distances within the second distance threshold range are greater than distances within the first distance threshold range;
determining, with the controller, that the detected distance of the user from the appliance falls within the second distance threshold range; and
selecting, with the controller, a second power mode from a first power mode and a second power mode different from the first power mode in response to the detected distance falling within the second distance threshold range.

20. The method of claim 19, the appliance comprising a user interface including a light emitting display, wherein:
operating the component of the appliance comprises deactivating, with the controller, the light emitting display of the user interface in response to selecting the second power mode, whereby deactivating the light emitting display results in no light emitted by the light emitting display.
